(19) United States
(12) Patent Application Publication
(10) Pub. No.: US 2007/0160444 A1
(43) Pub. Date: Jul. 12, 2007

(54) Binder

(75) Inventors: Paul Arthur Aries, West Midlands (UK); Ian Stuart Smith, Northants (GB)

Correspondence Address: MICHAEL BEST & FRIEDRICH, LLP, 100 EAST WISCONSIN AVENUE, SUITE 3300, MILWAUKEE, WI, 53202, US

(73) Assignee: ACCO UK LIMITED, Buckinghamshire (UK)

(21) Appl. No.: 11/426,044

(22) Filed: Jun. 23, 2006

(30) Foreign Application Priority Data
Jul. 1, 2005 (GB) 0513479.6

(51) Int. Cl. B42B 5/08

(52) U.S. Cl. 412/38

(57) ABSTRACT

A binder operable to bind together pages of a document, the binder including: means for measuring the document length, including first and second locating members which act to locate the pages of the document between them in a lengthwise direction, thereby measuring the length of the pages of the document; and means for using the document length measurement to select one or more settings of the binder, wherein the means for measuring the document length also comprises an operating member, movement of which causes movement of one or both locating members, to locate the pages of the document between the locating members.

### BACKGROUND OF THE INVENTION

The invention relates to improvements in binders, particularly the selection of settings of the binder.

Binders are used for binding together the pages of many differently-sized documents. Generally, the document width and/or thickness must be known by a user, and settings of the binder selected accordingly. For example, the user measures the document width and thickness in some way, and then selects various settings of the binder to indicate, for example, the document width, the document thickness, the size of an edge margin of the pages, the size of a back margin of the pages, the number of holes to be punched in the pages, and/or the size of comb or wire to be used to bind the pages. Generally, determination of the correct settings, and selection of each setting is carried out by the user. This can be time-consuming, and, if incorrect settings are selected can lead to poor quality binding, and even damage to the pages of the document and/or the binder.

### SUMMARY OF THE INVENTION

According to the invention there is provided a binder operable to bind together pages of a document, the binder including:
means for measuring the document length, including first and second locating members which act to locate the pages of the document between them in a lengthwise direction, thereby measuring the length of the pages of the document; and
means for using the document length measurement to select one or more settings of the binder,
   wherein the means for measuring the document length also comprises an operating member, movement of which causes movement of one or both locating members, to locate the pages of the document between the locating members

The locating members may be movable to locate the pages of the document between them. Alternatively, one of the locating members may be fixed and one of the locating members may be movable, to locate the pages of the document between them.

The operating member may comprise a knob. The operating member may be attached to the locating members by a drive mechanism. The drive mechanism may comprise a rack and pinion drive mechanism. Movement of the operating member may cause operation of the drive mechanism which may cause movement of one or both locating members. The operating member may be moved by a user of the binder.

The means for measuring the document length may comprise means to hinder movement of one or both locating members at one or more locations of the locating members. For one or both locating members, the means to hinder movement thereof may operate at one or more locations of the locating members when the locating members are positioned a distance apart which substantially corresponds to a standard paper length, for example, A4 standard paper length, or A5 standard paper, or USA standard paper length. For one or both locating members, the means to hinder movement thereof may comprise one or more indentations provided on one or both locating members and a resilient member positioned relative to one or both locating members to engage with the or each indentation to hinder the movement of the locating member. For one or both locating members, the position of the or each indentation may be such when the resilient member is engaged therein, the locating members are positioned a distance apart which substantially corresponds to a standard paper length. Thus a user of the binder is able to discern when a standard paper length is being measured, when movement of the or each locating member is hindered.

The locating members may act to centralise the pages of the document with respect to a punching mechanism of the binder. This allows the punching of partial holes at the ends of the length of the document to be avoided.

The means for using the document length measurement to select one or more settings of the binder may select a setting for an edge margin of the pages of the document.

The means for using the document length measurement to select one or more settings of the binder may select the setting for at least one punch of a punching mechanism of the binder. The setting of the punch may be selected such that the punch is operative to punch a hole in the pages of the document, or selected such that the punch is inoperative to punch a hole in the pages of the document. The means for using the document length may comprise a punch selector operating member to select the setting of the punch. The punch selector operating member may engage with a locating member of the means to measure the document length, to select the setting for the punch.

The binder may be a comb-type binder, i.e. in which a comb is used to bind the pages of the document. The binder may be a wire-type binder, i.e. in which a wire is used to bind the pages of the document.

The binder may comprise means for overriding one or more settings selected according to the document thickness measurement and/or the document length measurement. This may comprise an override operating member. The override operating member may be operated by a user of the binder. The override operating member may be used to select a different setting for a setting selected according to the document thickness measurement or the document length measurement. The binder may change the remainder of the settings according to the different setting which is selected.

According to a second aspect of the invention there is provided a method of binding the pages of a document, comprising
measuring the document length, and
using the document length measurement to select one or more settings of the binder.

### BRIEF DESCRIPTION OF THE DRAWINGS

An embodiment of the invention will now be described by way of example only, with reference to the accompanying drawings, in which:

FIG. 1 is a front view of a binder according to a first aspect of the invention;

FIG. 2 is a perspective representation of the binder of FIG. 1;

FIG. 3 is a perspective representation of a punch selector operating member and a locating member of the binder of FIG. 1; and

FIG. 4 is a perspective representation from above and the left hand side of the binder of FIG. 1.

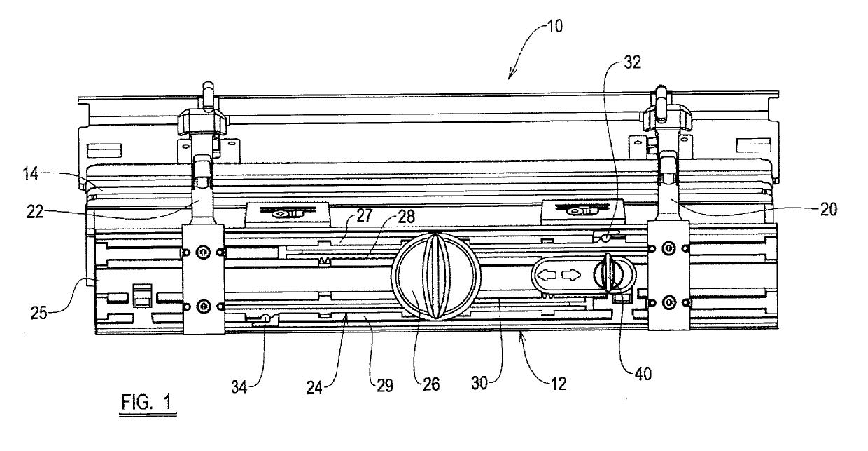

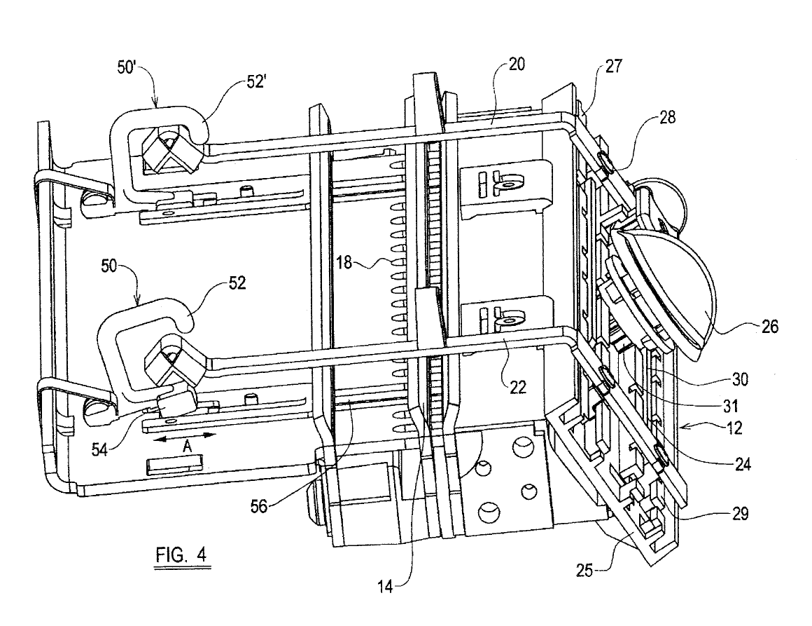

FIGS. 1 to 4 show a binder 10. This comprises means for measuring the length of pages of a document to be bound by the binder, shown generally at 12. The binder further comprises a punch mechanism having a plurality of punches 18, each of which may be used to punch a hole in the pages of the document, and a binding element holder 16.

### DETAILED DESCRIPTION

The means to measure the document length comprises a trough 14 in which the pages of the document are placed for measurement. The document length measurement means further comprises a first locating member 20 and a second locating member 22, a drive mechanism 24 and an operating member 26. Both the first locating member 20 and the second locating member 22 are movable, towards and away from each other. The drive mechanism 24 is provided on a front plate 25 and comprises racks 28, 30 (which are slidable side to side in sideways 27 and 29 respectively) and a pinion 31, which are engaged together. The rack 28 is attached to the first locating member 20, and the rack 30 is attached to the second locating member 22. The racks 28, 30 are meshed with the pinion 31, which is attached to the rear of the operating member 26. The operating member 26 comprises a knob. The knob is rotatable, in clockwise and anti clockwise directions.

The means for measuring the length of the pages of the document is used as follows. The pages of the document are placed in the trough 14, such that a lower part of each page is positioned between the first and second locating members 20, 22. The operating member 26 is then operated by a user of the binder 10, to rotate it in an anticlockwise direction. This causes the pinion 31 to rotate, which, in turn, causes movement of the racks 28, 30 and the first and second locating members 20, 22. This causes the first and second locating members 20, 22 to move towards each other, locating the pages of the document between them. The operating member 26 is turned until the first and second locating members 20, 22 move sufficiently to firmly trap the pages of the document between them, but not so as to distort the pages.

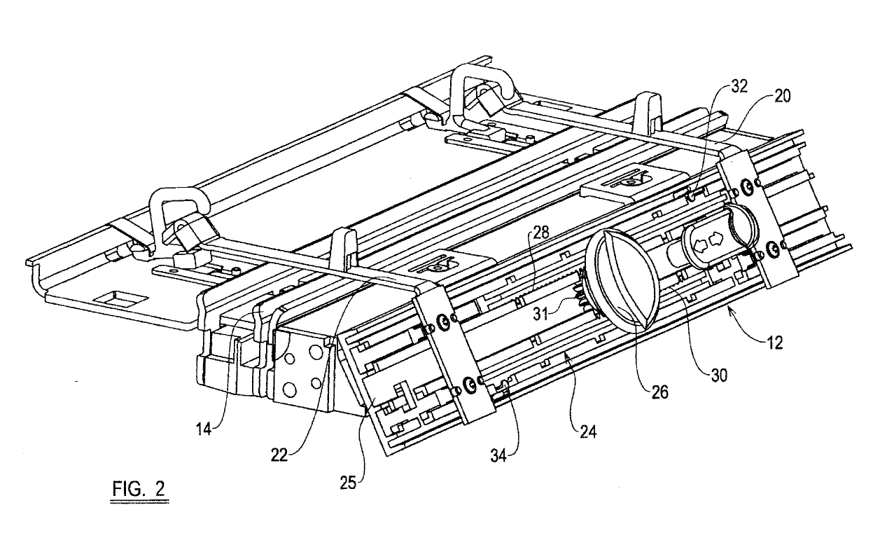

As the racks 28, 30 move, their movement is impeded at a number of locations by engagement of resilient spring members 32, 34 in indentations in the rack members 28, 30. The spring members 32, 34 are shown in FIGS. 1 and 2 engaged in one pair of such indentations. The alternative indentations are not visible as the relevant portions of the racks 28, 30 are concealed with the slideways 27, 29. The provision of the spring members 32, 34 and indentations allows the user to move the locating members 20, 22 until they measure the length of the document, and then, if this does not correspond to a standard length, to move the locating members 20, 22 away from each other until the next standard document length is reached, by engagement of the resilient spring members 32, 34. Choosing the standard document length, e.g. A4, A5, which best matches the actual length of the document, enables the correct number of holes to be punched in the document. Movement of the locating members 20, 22 to abut the ends of the document also centralises the document in the trough 14. This ensures that partial holes are not punched overlapping one or both ends of the document.

However, different lengths of document require either odd or even numbers of holes to be punched in the pages, for example an A4 document requires 21 holes whilst an A5 document requires 14 holes (assuming that the binding is being undertaken along the long side of the pages concerned). Therefore, once the user has undertaken the process described above they then need to ensure that the binder 10 is set up for an odd or even number of holes as appropriate, in order to avoid any holes being punched overlapping the edges of the pages. To do this the user must move the front plate 25 on which the drive mechanism 24 is provided to the correct location using knob 40 to the left of which are shown two arrows, one pointing in either direction. Operation of the knob 40 simply allows the user to push the front plate 25 to the left or right to the appropriate location for an odd or even number of holes.

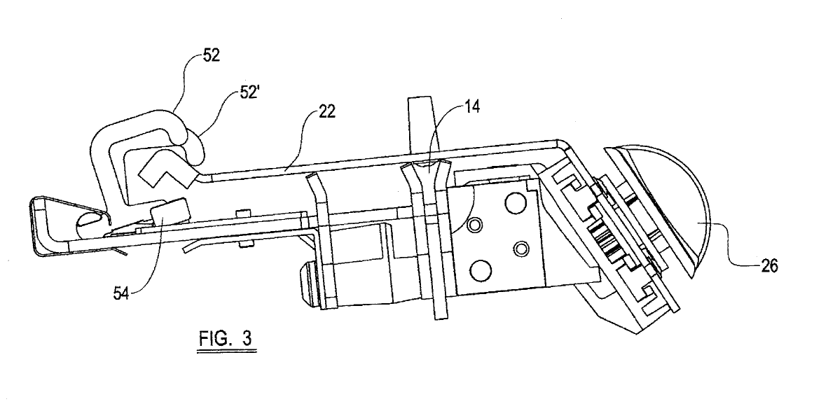

Referring in particular to FIG. 3, this shows a means for using the document length measurement to select the setting for a punch of the punching mechanism of the binder. The means for using the document length measurement comprises a punch selector operating member 50. The punch selector operating member comprises a lever 52. This is attached to a base 54. The base is movable in directions shown by the arrow A, to drive a punch 56 between an inoperative position and an operative position. When the document being measured has a length of approximately A5, the location of the locating member 22 is in such a position that the lever 52 engages with the locating member 22. This raises the lever 52 and the base 54, and when the base 54 is moved forwards, when it would normally engage with the punch 56, the base travels over the punch 56 and therefore does not cause operation of the punch. Thus the punch 56 does not punch a hole in the pages of the document. A similar punch selector operating member 50′ is provided for interaction with the locating member 20.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A binder operable to bind together pages of a document, the binder including:
means for measuring the document length, including first and second locating members which act to locate the pages of the document between them in a lengthwise direction, thereby measuring the length of the pages of the document; and
means for using the document length measurement to select one or more settings of the binder,
wherein the means for measuring the document length also comprises an operating member, movement of which causes movement of one or both locating members, to locate the pages of the document between the locating members.

2. A binder according to claim 1 in which both locating members are movable to locate the pages of the document between them.

3. A binder according to claim 1 in which the operating member is attached to the locating members by a drive mechanism, which comprises a rack and pinion drive mechanism.

4. A binder according to claim 3 in which movement of the operating member causes operation of the drive mechanism which causes movement of one or both locating members.

5. A binder according to claim 1 in which the means for measuring the document length comprises means to hinder movement of one or both locating members at one or more locations of the locating members.

6. A binder according to claim 5 in which for one or both locating members, the means to hinder movement thereof operates at one or more locations of the locating member when the locating members are positioned a distance apart which substantially corresponds to a standard paper length.

7. A binder according to claim 5 in which for one or both locating members, the means to hinder the movement of each locating member comprises one or more indentations provided on the locating member and a resilient member positioned relative to the locating member to engage with the or each indentation to hinder the movement of the locating member.

8. A binder according to claim 6 in which for one or both locating members, the means to hinder the movement of each locating member comprises one or more indentations provided on the locating member and a resilient member positioned relative to the locating member to engage with the or each indentation to hinder the movement of the locating member.

9. A binder according to claim 1 in which the locating members act to centralise the pages of the document with respect to a punching mechanism of the binder.

10. A binder according to claim 1 in which the means for using the document length measurement to select one or more settings of the binder selects a setting for an edge margin of the pages of the document.

11. A binder according to claim 1 in which the means for using the document length measurement to select one or more settings of the binder selects the setting for at least one punch of a punching mechanism of the binder.

12. A binder according to claim 11 in which the means for using the document length measurement comprises a punch selector operating member to select the setting of the punch.

13. A binder according to claim 12 in which the punch selector operating member engages with a locating member of the means to measure the document length, to select the setting for the punch.
